(19) United States
(12) Patent Application Publication
(10) Pub. No.: US 2009/0293438 A1
(43) Pub. Date: Dec. 3, 2009

(54) SAFETY DEVICE

(75) Inventor: Roy Owen Burek, Chester (GB)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(73) Assignee: CHARLES OWEN AND COMPANY (BOW) LIMITED, Wrexham (GB)

(21) Appl. No.: 12/437,879

(22) Filed: May 8, 2009

(30) Foreign Application Priority Data
May 29, 2008 (GB) 0809758.6

(51) Int. Cl. B68C 1/08

(52) U.S. Cl. 54/44.6; 54/44.1; 54/65

(57) ABSTRACT

A safety device (18, FIG. 1) for a horse 12 comprises an air bag 24 and an inflation means, the safety device (18) being adapted to be mounted to a saddle 14 or saddle pad 16. The airbag 24 is substantially horseshoe shaped and when inflated is adapted to extend around a horse's hind quarters up one flank, across the back of the horse, and down the other flank. Inflation of the airbag 24 is triggered when the safety device is moved to a substantially vertically disposed position as encountered in a rotational fall. A second embodiment of airbag 42 with a pyramidal shape is shown in FIG. 4.

### BACKGROUND OF THE INVENTION

The present invention relates to a safety device for a protecting a rider in a horse fall.

It is recognised that a rotational or somersault fall is the most dangerous of horse falls. In a rotational fall, a horse usually impacts a solid object such as a fence, for example, during cross country jumping or hunting. The horse usually impacts the object above the knee, with the effect that the hind quarters of the horse rotate upwards and continue rotating until the horse lands on its back or on its side, and in so doing crushing the rider beneath the horse causing serious or fatal injury. In some cases the rider is never unseated due to the speed of the rotation, for example, in accidents when the horse is travelling at speed. The rider is often unable to move out of the path of the falling horse, before it hits the ground. In some cases the horse is also injured, also sometimes fatally.

In 2006, there were 51 rotational falls recorded by the Federation Equestrian Internationale (FEI), resulting in 10 serious rider injuries and 2 rider fatalities. In a 13 month period from 2007 to 2008, there were 11 rider fatalities caused by rotational falls during the cross-country phase of eventing competitions. A rotational fall can also be caused, for example, by a road vehicle colliding with a horse.

It is an object of the invention to provide a safety device for protecting a rider in a horse fall and particularly in a rotational fall.

### SUMMARY OF THE INVENTION

According to a first aspect of the present invention there is provided a safety device for a horse comprising an air bag and an inflation means, the safety device being adapted to be mounted to a saddle or saddle pad.

The airbag may be substantially horseshoe shaped, which when inflated is adapted to extend around a horse's hind quarters up one flank, across the back of the horse, and down the other flank.

The safety device is advantageous, particularly in a rotational fall, because the inflated airbag takes the weight of the hind quarters of the horse and at least partially absorbs the impact force of the falling horse, thus protecting the rider. The cushioning effect of the airbag also reduces the trauma injury to the horse, for example, it may prevent the horse breaking its back.

The airbag depth may be substantially up to around 1 m, when inflated. Alternatively the airbag depth may be substantially 0.75 m. This is sufficient to protect the rider in substantially all fall positions. For example, if the rider falls directly underneath the horse or to one side of the horse in a rotational fall, then the airbag will keep the hind quarters of the horse elevated from the ground, giving the rider opportunity to move away from the fallen horse. Furthermore, if the rider is unconscious or unable to move due to injury, then a third party is able to move the rider away from the horse and out of danger.

The airbag width may be substantially up to around 0.5 m, when inflated.

In an alternative embodiment the airbag may be substantially shaped as a pyramid and when inflated, a base of the pyramid may be adapted to extend around a horse's hind quarters up one flank, across the back of the horse, and down the other flank.

An apex of the inflated pyramid airbag may be substantially 1 m from the base of the pyramid.

Vertices disposed at the base of the inflated pyramid may be adapted to be disposed partway down the flanks of the horse.

The pyramidal airbag supports the back and flanks of the horse in a fall in the similar way to the horseshoe shaped airbag. Advantageously, the pyramidal airbag may be smaller in size prior to inflation.

The inflation means may be triggered by an output from a sensing means, for example, a level indicator.

The level indicator may trigger the inflation means causing inflation of the airbag, when the level indicator is moved to a substantially vertical position. The movement may be in a first plane aligned with the longitudinal axis of the horse. This movement would usually be from a substantially horizontal position encountered in usual riding activities.

This is advantageous because the airbag will be inflated in a rotational fall as the back of the horse moves through a vertical position from a horizontal position.

The level indicator may also trigger inflation of the airbag, when the sensing means is rotated sideways through a predetermined angle for example, greater than 30°. Optionally the level indicator may also trigger inflation of the airbag, when the sensing means is rotated sideways through and angle of greater than 15°. These movements are preferably in a second plane orthogonal to the first plane and the longitudinal axis of the horse.

This is advantageous because the airbag is inflated when the horse enters a sideway fall and reaches the point of no return or no recovery. The portions of the airbag extending around the flanks of the horse prevent the rider's legs and hips from being crushed as the horse falls onto its side.

The airbag is made from a fabric, which may be nylon.

The safety device may be housed within or attached to the pad.

A plurality of holes may be provided in the airbag allowing enhanced cushioning and controlled deflation of the airbag. The airbag may comprise several internal compartments.

According to a second aspect of the invention there is provided a safety saddle comprising a saddle and a safety device in accordance with the first aspect of the invention, the safety device being mounted to, or housed within the saddle.

According to a third aspect of the invention there is provided a saddle pad comprising a pad and a safety device in accordance with the first aspect of the invention, the safety device being mounted to, or housed within the pad.

The scope of the term “saddle pad” is intended to include a numnah, which is a pad shaped to fit to a saddle outline. Usually a saddle pad is disposed on a horse's back underneath the saddle, but a further cushioning pad, for example, made from sheepskin, foam or gel filled fabric, may be disposed between the saddle pad and saddle. For the purposes of this disclosure, such a cushioning pad is also intended to be included within the scope of the term “saddle pad”.

### BRIEF DESCRIPTION OF THE DRAWINGS

Examples of the invention will now be described, by way of example, with reference to the accompanying drawings, in which:

FIG. 1 shows a schematic side view of a horse and rider;

FIG. 2 shows a schematic side view of the horse and rider of FIG. 1 in a rotational fall with a first embodiment of airbag inflated;

FIG. 3 shows a schematic rear view of the horse and the fully inflated airbag of FIG. 2; and

FIG. 4 shows a schematic rear view of the horse and a second embodiment of fully inflated airbag.

### DETAILED DESCRIPTION OF THE ILLUSTRATIVE EMBODIMENTS

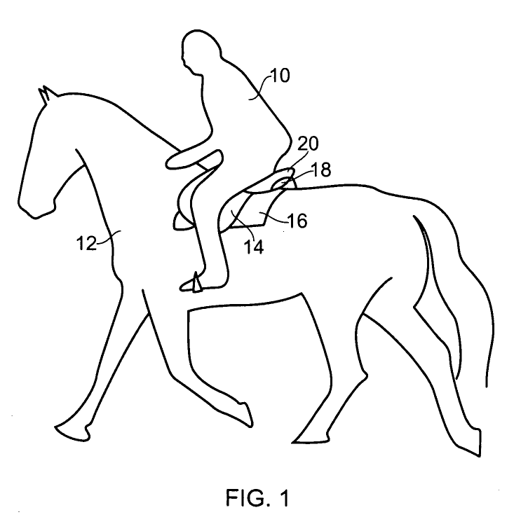

Referring firstly to FIG. 1, a rider 10 is shown mounted on a horse 12. A saddle 14 is fitted to the horse in usual manner on top of a saddle pad 16. A safety device 18 is mounted within a cantle 20 of the saddle 14, but in other embodiments the safety device 18 is either attached to the rear of the saddle, for example, underneath the cantle 20 or is attached to a portion of the saddle pad 16 extending to the rear of the saddle 14.

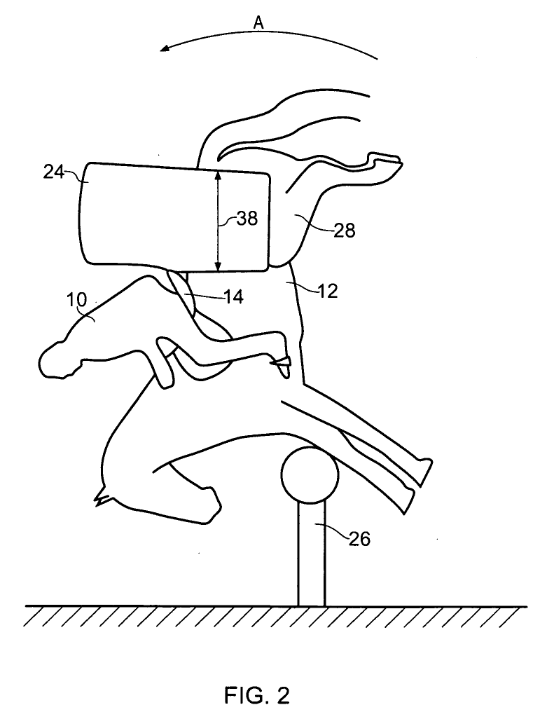

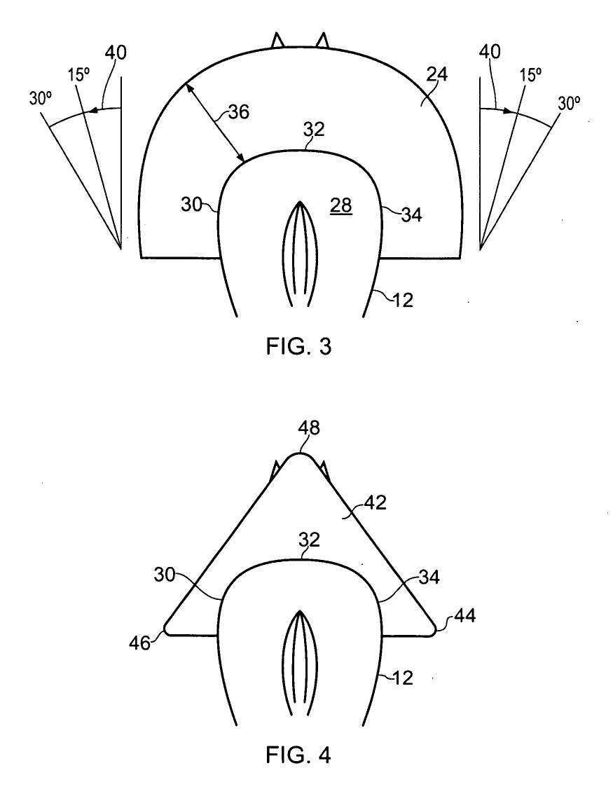

The safety device 18 includes an airbag 24, a first embodiment of which is shown inflated in FIGS. 2 and 3, an inflation means and a trigger for triggering inflation of the airbag 24 by the inflation means. The trigger includes sensing means such as a level indicator which is responsive to its physical disposition. The sensing means triggers inflation of the airbag 24 when it is moved to a substantially vertical position, for example, as encountered in a rotational fall. In FIG. 2, the horse 12 and rider 10 are shown entering a rotational fall after the horse has hit an obstruction 26 with its front legs. The direction of the rotational fall is indicated by arrow A.

The airbag 24 has inflated behind the rider 10 over the hind quarters 28 of the horse 10. Typically the inflation means inflates the airbag 24 within a fraction of a second, once triggered. The airbag 24 is filled with a gas, created in usual manner, by means of a chemical reaction.

Referring in particular to FIG. 3, the inflated airbag 24 is substantially horseshoe shaped and sits on the hind quarters 28 of the horse 12. The airbag 24 extends around the left flank 30 of the horse, over the back 32 of the horse and over the right flank 34 of the horse. The airbag depth or distance that the airbag extends outwardly from the horse's back and flanks, as indicated by the arrow 36, is ideally 0.75 m, but maybe up to 1 m for a particularly large horse. The width of the airbag 24, indicated by arrow 38 in FIG. 2, is typically 0.5 m, but may be made larger or smaller to fit horses of different sizes.

The trigger is also adapted to trigger inflation of the airbag 24 when the horse 12 enters a sideways fall. In a sideways fall, once the back of the horse 12 and top of the saddle 14 have rotated sideways through an angle of 15°, as indicated by arrow 40 in FIG. 3, it is unusual for a horse to regain its footing. If the horse rotates sideways beyond 30°, then even with a professional rider, it is almost certainly beyond the point of recovery and will fall sideways to the ground. Accordingly, the trigger can be adjusted to trigger in a sideways fall when the back of the saddle moves between 15° and 30° to one side or the other, ie in an orthogonal direction to the movement in a rotational fall. Greater pre-determined angles can also be selected, if desired. The inflated portions of the airbag 24 extending around the flanks of the horse 30, 34 protect the riders legs and hips in a sideways fall.

Referring now to FIG. 4, a second embodiment of airbag is shown at 42 in FIG. 4. The airbag 42 is housed and inflated in a rotational and sideways fall in the same way as the airbag 24, but has a different inflated shape. The airbag 42 is substantially pyramidal with lower vertices 44,46 and an apex 48. The base of inflated airbag 42 is recessed and shaped to extend around the left flank 30 of the horse, over the back 32 of the horse and over the right flank 34 of the horse. The apex 48 is disposed directly above the back of the horse 12.

The airbags 24, 42 are made from fabric, typically nylon, and may be coated, as required. The airbags optionally have a plurality of small holes which allow gases inside the airbags after inflation to seep out in a controlled manner. This provides an enhanced cushioning effect when the horse hits the ground.

The safety device 18 may have a switch to turn the safety device 18 on and off. This prevents accidental inflation of the airbag 24, when the saddle 14 is not in use on a horse 12. It is envisaged that the safety device can be used in any horse riding event, training or recreational activity, where a horse is jumping and there is a risk of the horse falling. Different sizes of airbags 24, 42 can be utilized for different sizes of horse and saddle, and it is envisaged that several lives can be saved every year, through use of the safety device 18.

It is understood that variations may be made in the foregoing without departing from the scope of the invention. For example, the elements and teachings of the various illustrative embodiments may be combined in whole or in part in some or all of the illustrative embodiments. In addition, one or more of the elements and teachings of the various illustrative embodiments may be omitted, at least in part, and/or combined, at least in part, with one or more of the other elements and teachings of the various illustrative embodiments.

Although illustrative embodiments of the invention have been shown and described, a wide range of modification, changes and substitution is contemplated in the foregoing disclosure. In some instances, some features of the invention may be employed without a corresponding use of the other features. Accordingly, it is appropriate that the appended claims be construed broadly and in a manner consistent with the scope of the invention.

1. A safety device for a horse comprising an air bag and an inflation means, the safety device being adapted to be mounted to a saddle or saddle pad.

2. A safety device as claimed in claim 1, in which the airbag is substantially horseshoe shaped and when inflated is adapted to extend around a horse's hind quarters up one flank, across the back of the horse, and down the other flank.

3. A safety device as claimed in claim 1, in which the airbag depth is substantially up to around 1 m, when inflated.

4. A safety device as claimed in claim 3, in which the airbag depth is substantially 0.75 m.

5. A safety device as claimed in claim 1, in which the airbag width is substantially up to around 0.5 m, when inflated.

6. A safety device as claimed in claim 1, in which the airbag is substantially shaped as a pyramid and when inflated, a base of the pyramid is adapted to extend around a horse's hind quarters up one flank, across the back of the horse, and down the other flank.

7. A safety device as claimed in claim 6, in which an apex of the inflated pyramid airbag is substantially 1 m from the base of the pyramid.

8. A safety device as claimed in claim 6, in which vertices at the base of the inflated pyramid are adapted to be disposed partway down the flanks of the horse.

9. A safety device as claimed in claim 1, in which the inflation means is triggered by an output from a sensing means.

10. A safety device as claimed in claim 9, in which the sensing means triggers the inflation means causing inflation of the airbag, when the sensing means is moved from a substantially horizontal position to a substantially vertical position in a first plane.

11. A safety device as claimed in claim 9, in which the sensing means triggers the inflation means causing inflation of the airbag, when the sensing means is rotated sideways through a predetermined angle from the vertical in a second plane.

12. A safety device as claimed in claim 11, in which the predetermined angle is 15°.

13. A safety device as claimed in claim 11, in which the predetermined angle is 30°.

14. A safety device as claimed in claim 1, in which the airbag is made from a fabric.

15. A safety device as claimed in claim 14, in which the fabric is nylon.

16. A safety device as claimed in claim 1, in which the airbag is provided with a plurality of holes allowing cushioning and controlled deflation of the airbag.

17. A safety saddle comprising a saddle and a safety device, the safety device comprising an air bag and an inflation means, the safety device being adapted to be mounted to or housed within the saddle.

18. A saddle pad comprising a pad and a safety device, the safety device comprising an air bag and an inflation means, the safety device being adapted to be housed within or attached to the saddle pad.
